(19) United States
(12) Patent Application Publication
(10) Pub. No.: US 2011/0242726 A1
(43) Pub. Date: Oct. 6, 2011

(54) ENERGY STORAGE DEVICE

(75) Inventor: Chien-Chiang CHAN, New Taipei City (TW)

(73) Assignee: Chien-Chiang CHAN, New Taipei City (TW)

(21) Appl. No.: 13/072,781

(22) Filed: Mar. 28, 2011

(30) Foreign Application Priority Data
Apr. 1, 2010 (TW) 99110114

(51) Int. Cl. H01G 4/06

(52) U.S. Cl. 361/311

(57) ABSTRACT

An energy storage device is disclosed in the invention. The energy storage device includes a first electrode, a second electrode, a dielectric layer and a magnetic portion or a magnetic material. The dielectric layer is disposed between the first electrode and the second electrode. The dielectric layer cooperates with the first electrode and the second electrode for achieving the capacitance effect, such that a plurality of positive charges and a plurality of negative charges are accumulated on the first electrode and the second electrode. The magnetic portion or the magnetic material is used for establishing a magnetic field. The magnetic field passes through the first electrode, the dielectric layer and the second electrode.

### RELATED APPLICATIONS

This application claims priority to Taiwan Patent Application Serial Number 99110114, filed Apr. 1, 2010, which is herein incorporated by reference.

### BACKGROUND

1. Technical Field

The present disclosure relates generally to an energy storage device, and more particularly to an energy storage device with magnetic material.

2. Description of Related Art

With a continuous development of electronic technology, integrated circuits have been developed toward high-density components, miniaturization, and high-integrated components. Various types of active devices (e.g. bipolar junction transistors and field effect transistors) and passive devices (e.g. resistors, capacitors, and inductors) are utilized in the integrated circuits. For instance, a more complex capacitor network is needed for the circuit that has to translate electrical phase signal, and a power-matching module is disposed in the integrated circuits for a differential input signal or a differential output signal, in which the capacitor network is also needed in the power-matching module.

For example, capacitors are usually used in applications such as a direct-current isolation of the power source, a full half-wave rectifier, a filter, a signal oscillation generator, etc. The conventional capacitors are, for example, metal-insulator-metal capacitor (MIM), metal-oxide-metal capacitor (MOM), electrolytic capacitor, and later developed capacitors including ceramic capacitor, paper capacitor, and mica capacitor.

Conventional capacitors basically occupy the space on the semiconductor substrate, and the space would not be used by other capacitors on the integrated circuit chip. Therefore, the space on the semiconductor substrate will be insufficient. When the requirements of advanced technology are still growing, a demand of putting more electrical components in a smaller area of the semiconductor is also increased. Therefore, it is expected in integrated circuits design that a smallest area for the capacitors is used, and characteristics of maximum capacitance value, low leakage current, and high stability can be achieved in capacitor design.

A conventional parallel plate capacitor is used as an example in related prior art. The formula of ideal capacitance value of the conventional parallel plate capacitor is C=k(εₒ A/d), wherein C is capacitance value, k is dielectric constant, εₒ is permittivity, A is parallel plate area, and d is a distance between two parallel plates. The following methods are adopted by related capacitor manufacturers for achieving maximum capacitance value. These methods are:

(1) Trying to Increase the Equivalent Area (A) of the Parallel Plates:

Without increasing the total area of the components, the contact surface between the metal parallel plate and the dielectric layer is usually designed in corrugated structure, saw tooth structure or trough structure, or a porous material is adopted for increasing the parallel plate area. However, the process of this method is relatively complex and has higher manufacturing cost.

(2) Increasing the Permittivity (εₒ) of the Dielectric Layer:

A good dielectric material is helpful for increasing the capacitance value, but the manufacturing cost is relatively high, and some of the dielectric materials are unstable or even cause the environment pollution.

(3) Decreasing the Distance (d) Between Two Parallel Palates:

A newest semiconductor process technology is used for decreasing the distance between two parallel palates of the capacitor (in general, the distance is about the thickness of the dielectric layer) to be extremely short. However, when the distance between two parallel plates of the capacitor is too short, the dielectric performance will be decreased, some of the charges may pass through the dielectric layer by tunnel effect, and the amount of storage charges are decreased.

Therefore, the present disclosure provides an energy storage device disposed with the magnetic material inside, and the magnetic field formed by the magnetic material can be used for changing the moving direction and the charge ordering in the energy storage device, raising the permittivity for achieving a higher electrical energy storage efficiency, and accelerating the chemical reaction rate to solve the issues above.

### SUMMARY

One aspect of the present invention is to provide an energy storage device.

According to one embodiment of the present invention, the energy storage device includes a first electrode, a second electrode, a dielectric layer, and a magnetic portion. The dielectric layer is disposed between the first electrode and the second electrode. The dielectric layer cooperates with the first electrode and the second electrode for achieving a capacitance effect, such that a plurality of positive charges and a plurality of negative charges are accumulated on the first electrode and the second electrode, respectively. The magnetic portion is used for establishing a magnetic field. The magnetic field passes through the first electrode, the dielectric layer, and the second electrode.

According to another embodiment of the present invention, the energy storage device includes a first electrode, a second electrode, a dielectric layer, and a magnetic material. The dielectric layer is disposed between the first electrode and the second electrode. The dielectric layer cooperates with the first electrode and the second electrode for achieving a capacitance effect, such that a plurality of positive charges and a plurality of negative charges are accumulated on the first electrode and the second electrode, respectively. The magnetic material is doped in at least one of the first electrode and the second electrode. The magnetic material is used for establishing a magnetic field. The magnetic field passes through the first electrode, the dielectric layer, and the second electrode.

Compared to the prior art in which the capacitors are most emphasized in structure difference (e.g. the shape of electrode, the material of dielectric layer, the thickness of dielectric layer, the contact area, etc.), the energy storage device in the present disclosure includes an additional magnetic portion for establishing the magnetic field. The charge ordering of the energy storage device can be changed by the magnetic field for increasing the energy storage efficiency of the energy storage device.

It is to be understood that both the foregoing general description and the following detailed description are by examples, and are intended to provide further explanation of the invention as claimed.

### BRIEF DESCRIPTION OF THE DRAWINGS

FIG. 1 shows a cross-sectional view of the energy storage device according to the first embodiment of the present invention.

FIG. 2 shows a diagram of charge operation of the energy storage device shown in FIG. 1 when the energy storage device is electrically connected to the external power source.

FIG. 3A shows a cross-sectional view of the energy storage device according to the second embodiment of the present invention.

FIG. 3B shows a cross-sectional view of the energy storage device according to the third embodiment of the present invention.

FIG. 3C shows a cross-sectional view of the energy storage device according to the fourth embodiment of the present invention.

FIG. 3D shows a cross-sectional view of the energy storage device according to the fifth embodiment of the present invention.

FIG. 4A shows a cross-sectional view of the energy storage device including the magnetic portion according to one embodiment of the present invention.

FIG. 4B shows a cross-sectional view of the energy storage device including the magnetic portion according to one embodiment of the present invention.

FIG. 4C shows a cross-sectional view of the energy storage device including the magnetic portion according to one embodiment of the present invention.

FIG. 5 shows a cross-sectional view of the energy storage device according to the sixth embodiment of the present invention.

### DETAILED DESCRIPTION

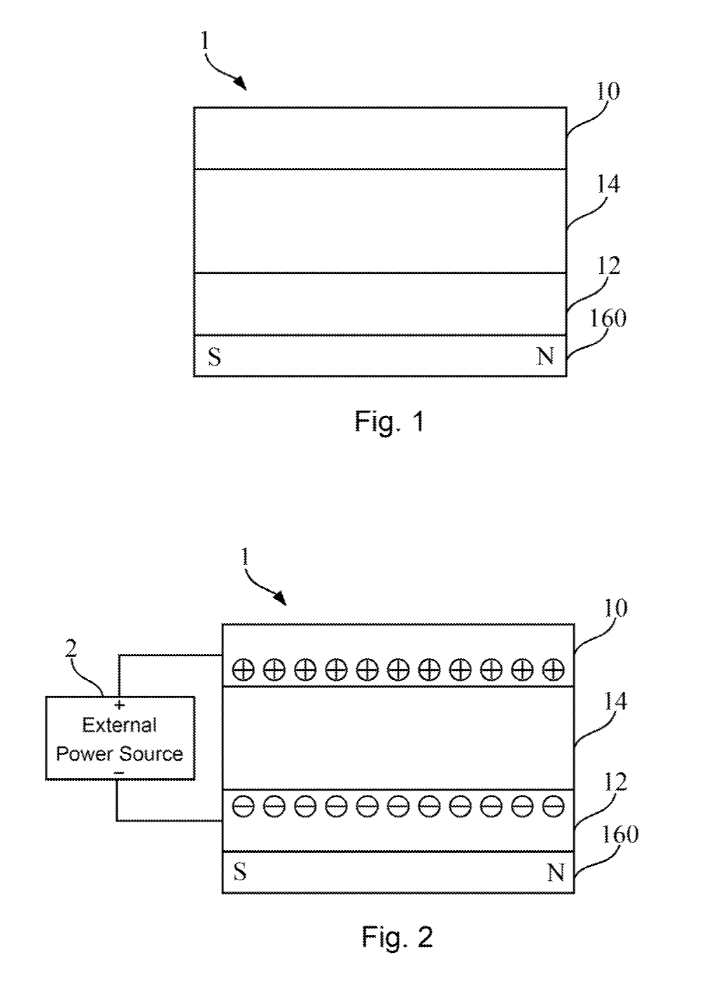

Referring to FIG. 1, FIG. 1 shows a cross-sectional view of the energy storage device according to the first embodiment of the present invention. As shown in FIG. 1, the energy storage device 1 includes a first electrode 10, a second electrode 12, a dielectric layer 14, and a magnetic portion 160. Basically, the first electrode 10 and the second electrode 12 are good conductors or semiconductors of electricity. The dielectric layer 14 disposed between the first electrode 10 and the second electrode 12 is basically formed by a dielectric material with relatively low conductivity, and is used for cooperating with the first electrode 10 and the second electrode 12 for achieving a capacitance effect.

In FIG. 1, a solid-state capacitor is used in an exemplary illustration of the energy storage device 1. In practice, the energy storage device 1 can be a non-chemical capacitor such as the solid-state capacitor, a mica capacitor, a ceramic capacitor, a plastic capacitor, or a semiconductor capacitor. Besides, in another embodiment of the present invention, the energy storage device 1 can also be a chemical capacitor such as an electrolytic capacitor or a super capacitor. When the capacitor is the electrolytic capacitor, the first electrode or the second electrode includes an electrolyte.

Also referring to FIG. 2, FIG. 2 shows a diagram of charge operation of the energy storage device shown in FIG. 1 when the energy storage device is electrically connected to the external power source. As shown in FIG. 2, when operator connects an external power source 2 (e.g. battery, power supply, direct-current power generator, etc.) electrically to the first electrode 10 and the second electrode 12 of the energy storage device 1, the energy storage device 1 is charged by the external power source 2. A difference of electric potential is formed between the first electrode 10 and the second electrode 12 by the external power source 2 for establishing an electric field. As a result, a plurality of positive charges are accumulated at the first electrode 10 and a plurality of negative charges are accumulated at the second electrode 12 in this embodiment. It is not intended to limit that the plurality of positive charges and the plurality of negative charges are accumulated respectively at the first electrode 10 and the second electrode 12 in the present disclosure. In practice, when the difference of electric potential formed by the external power source 2 changes in opposite way, the plurality of positive charges and the plurality of negative charges are accumulated at opposite positions, in accordance with practical application.

For a specific explication, a magnetic portion is further disposed in the energy storage device 1 for establishing the magnetic field. The magnetic field passes through the first electrode 10, the dielectric layer 14, and the second electrode 12. In this embodiment, the magnetic portion is a magnetic layer 160 disposed on the external surface of the second electrode 12 (shown in FIG. 2). The magnetic portion (i.e. the magnetic layer 160) is formed by a magnetic material. For example, the magnetic portion (i.e. the magnetic layer 160 in this example) is formed by the magnetic metal material selected from the group consisting of iron, nickel and cobalt or formed by an alloy or an oxide made by the magnetic metal material. An electrically insulated material can be sprayed or coated on a surface of the magnetic material (i.e. the magnetic layer 160). In other words, an insulated process can be performed to the electrically conductive magnetic material to prevent the adjacent electrodes from being affected by the metal material causing the short effect or other negative effects.

In another embodiment, the magnetic portion (i.e. the magnetic layer 160) also can be formed directly by an electrically insulated magnetic material, such as magnetic ceramic material or other magnetic rare earth elements.

As shown in FIG. 2, the magnetic layer 160 is a single magnetic unit in the first embodiment. The magnetic unit has a north magnetic pole (N-pole) and a south magnetic pole (S-pole). In this embodiment, the magnetic poles are located at the left side and the right side of the magnetic layer 160, respectively. It is not intended to limit the magnetic layer as single magnetic unit and it is also not intended to limit the magnetic poles with the same purpose in the present disclosure.

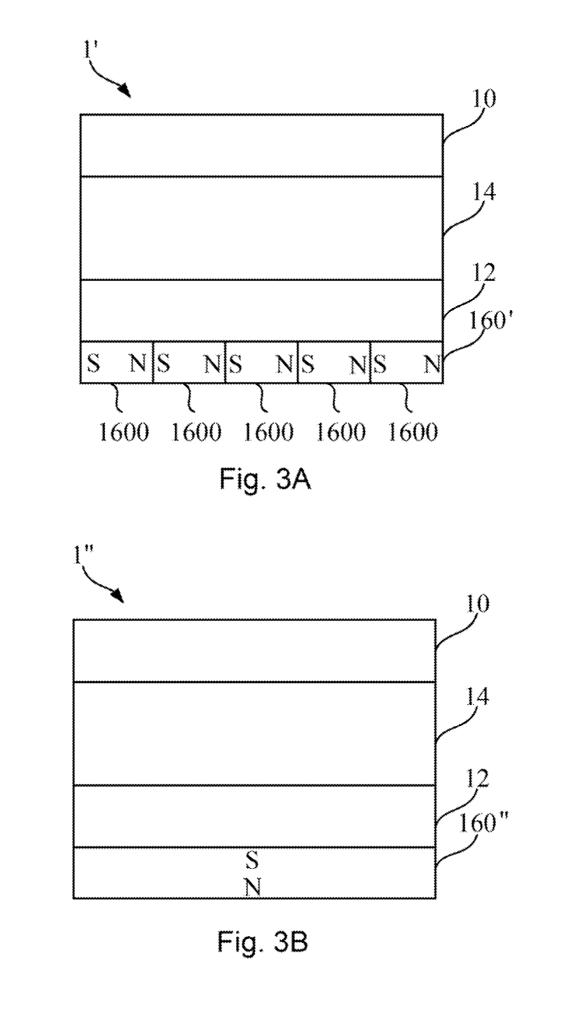

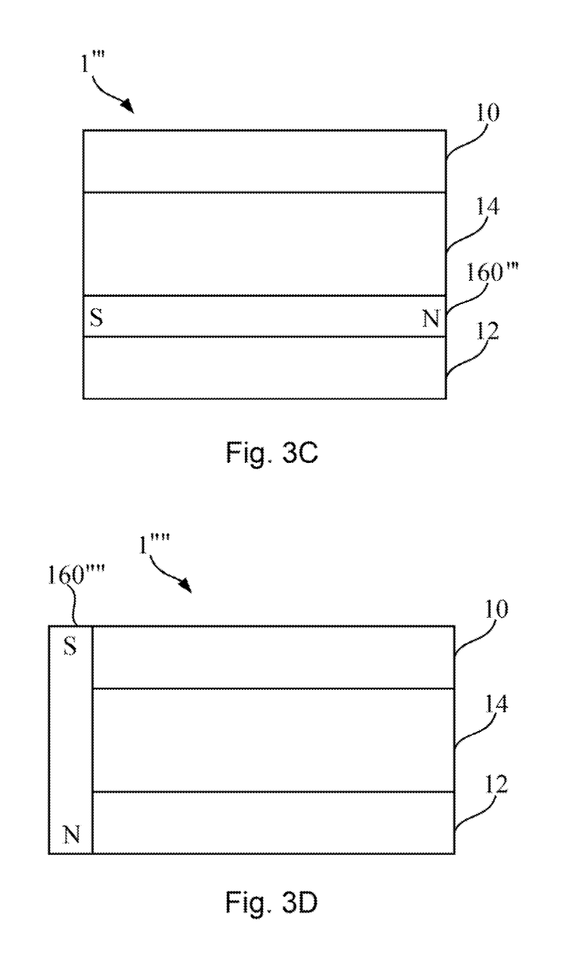

Referring to FIG. 3A and FIG. 3B, FIG. 3A shows a cross-sectional view of the energy storage device 1′ according to the second embodiment of the present invention. FIG. 3B shows a cross-sectional view of the energy storage device 1″ according to the third embodiment of the present invention. As shown in the second embodiment in FIG. 3A, the major difference of the energy storage device 1′ is that the magnetic layer 160′ includes a plurality of sub-magnetic units 1600, each sub-magnetic unit 1600 has the north magnetic pole and the south magnetic pole, and the sub-magnetic units 1600 are arranged in the neighbor with the opposite magnetic poles (shown in FIG. 3A).

As shown in the third embodiment in FIG. 3B, the major difference of the energy storage device 1″ is that the magnetic poles of the magnetic layer 160″ are not in the horizontal direction; instead, the magnetic poles of the magnetic layer 160″ are in the vertical direction for establishing the magnetic field in a different direction.

Furthermore, it is not intended to limit the disposed position of the magnetic portion in the previous embodiment. In practice, the magnetic layer can be disposed between the dielectric layer and the first electrode or between the dielectric layer and the second electrode, or disposed on any one lateral surface of four lateral surfaces formed by the first electrode, the second electrode, and the dielectric layer. Please refer to FIG. 3C and FIG. 3D. FIG. 3C shows a cross-sectional view of the energy storage device 1′″ according to the fourth embodiment of the present invention. As shown in the fourth embodiment in FIG. 3C, the magnetic portion (i.e. the magnetic layer 160′″) of the energy storage device 1′″ is disposed between the second electrode 12 and the dielectric layer 14. The non-conductive magnetic layer 160′″ also can be used as the dielectric material and establish the magnetic field as well. FIG. 3D shows a cross-sectional view of the energy storage device 1″″ according to the fifth embodiment of the present invention. As shown in the fifth embodiment in FIG. 3D, the magnetic portion (i.e. the magnetic layer 160″″) of the energy storage device 1″″ is disposed on the left side surface formed by the first electrode 10, the second electrode 12, and the dielectric layer 14. The magnetic field can be established by the magnetic layer 160″″, and the magnetic layer 160″″ having non-conductive material or insulated material covered on the surface thereof will not cause a short circuit between the electrode layers.

Furthermore, it is not intended to limit the magnetic portion as a single magnetic layer in the energy storage device of the present disclosure. In the other embodiment, the magnetic portion may include a plurality of magnetic layers. The magnetic layers can be disposed between the dielectric layer and the first electrode or between the dielectric layer and the second electrode, or disposed on at least one lateral surface of four lateral surfaces formed by the first electrode, the second electrode, and the dielectric layer.

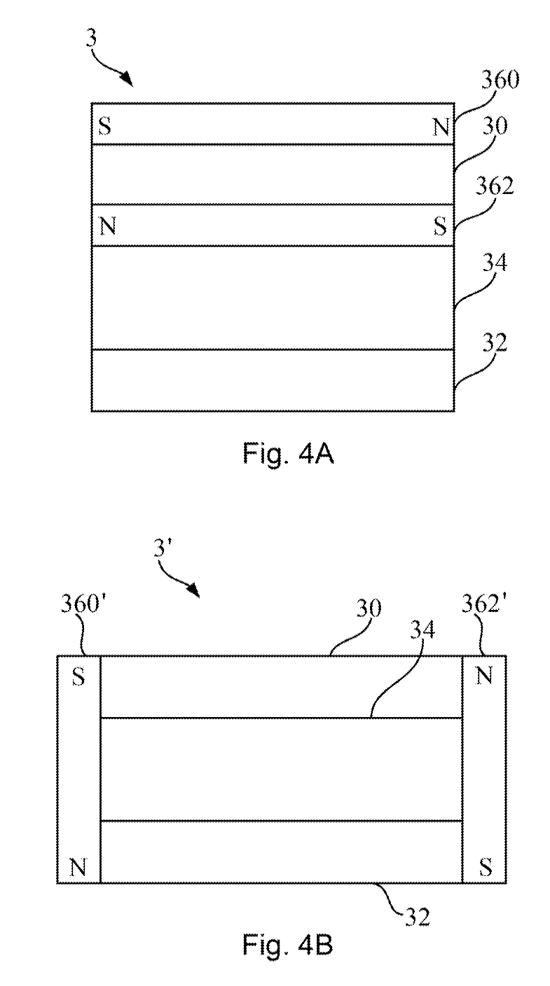

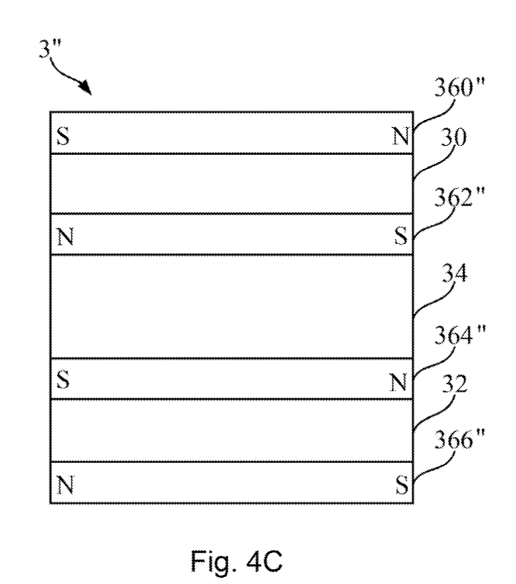

Please refer to FIG. 4A, FIG. 4B, and FIG. 4C. FIG. 4A to FIG. 4C shows a cross-sectional view of the energy storage device including the magnetic portion according to different embodiments of the present invention.

As shown in FIG. 4A, the magnetic portion of the energy storage device 3 includes two magnetic layers (magnetic layer 360 and magnetic layer 362), in which the magnetic layer 360 is disposed on the upper side surface of the first electrode 30, and the magnetic layer 362 is disposed between the first electrode 30 and the dielectric layer 34. The direction of magnetic poles in the magnetic layer 360 can be opposite to the direction of magnetic poles in the magnetic layer 362 (as shown in FIG. 4A). In another embodiment, the directions of magnetic poles in the magnetic layer 360 and the magnetic layer 362 can be identical.

As shown in FIG. 4B, the magnetic portion of the energy storage device 3′ includes two magnetic layers (magnetic layer 360′ and magnetic layer 362′), in which the magnetic layer 360′ is disposed on the left side surface formed by the first electrode 30, the second electrode 32, and the dielectric layer 34. The magnetic layer 362′ is disposed on the right side surface formed by the first electrode 30, the second electrode 32, and the dielectric layer 34.

In another embodiment, as shown in FIG. 4C, the magnetic portion of the energy storage device 3″ includes four magnetic layers (magnetic layer 360″, magnetic layer 362″, magnetic layer 364″, and magnetic layer 366″). The magnetic layer 360″ is disposed on the upper side surface of the first electrode 30. The magnetic layer 362″ is disposed between the first electrode 30 and the dielectric layer 34. The magnetic layer 364″ is disposed between the second electrode 32 and the dielectric layer 34. The magnetic layer 366″ is disposed on the lower side surface of the second electrode 32.

Therefore, the magnetic portion of the energy storage device of the present disclosure may include at least one magnetic layer, and each magnetic layer can be a single magnetic unit, or each magnetic layer may include a plurality of sub-magnetic units that are respectively disposed at different positions in the energy storage device for establishing different types of magnetic fields.

In sum, the magnetic portion is disposed additionally in the energy storage device of the present disclosure for establishing the magnetic field, such that the charge ordering of energy storage device can be changed and the permittivity of energy storage device can be increased by the magnetic field for increasing the energy storage efficiency of the energy storage device.

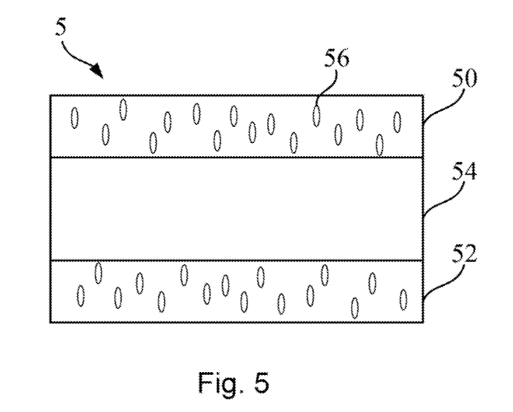

It is not intended to limit the energy storage device having the magnetic portion (e.g. magnetic layer) independently disposed in previous embodiments of the present invention. FIG. 5 shows a cross-sectional view of the energy storage device 5 according to the sixth embodiment of the present invention. As shown in the sixth embodiment of the present invention in FIG. 5, there is no magnetic portion in the energy storage device 5. Instead, the energy storage device 5 has the magnetic material 56 doped directly in the first electrode 50 or doped in the second electrode 52, or simultaneously doped in the first electrode 50 and the second electrode 52. As a result, the magnetic material 56 can be used for establishing the magnetic field passing through the first electrode 50, the dielectric layer 54 and the second electrode 52.

Therefore, the electrode of the energy storage device 5 has magnetic characteristics by doping the magnetic material 56 into the electrode of the energy storage device 5. Different types of the magnetic fields can be established at any position in the energy storage device by doping a particular ratio of the magnetic material in different electrodes or at different positions on the electrode. In sum, the energy storage device is doped with additional magnetic material for establishing the magnetic field in this embodiment, such that the charge ordering of energy storage device can be changed and the permittivity of energy storage device can be increased by the magnetic field for increasing the energy storage efficiency of the energy storage device, and the volume of the energy storage device will not be affected.

The embodiments were chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. An energy storage device, comprising:
a first electrode;
a second electrode;
a dielectric layer disposed between the first electrode and the second electrode, the dielectric layer cooperating with the first electrode and the second electrode for achieving a capacitance effect, such that a plurality of positive charges and a plurality of negative charges are accumulated on the first electrode and the second electrode, respectively; and
a magnetic portion for establishing a magnetic field, the magnetic field passing through the first electrode, the dielectric layer, and the second electrode.

2. The energy storage device of claim 1, wherein the magnetic portion is formed by an electrically insulated magnetic material.

3. The energy storage device of claim 1, wherein the magnetic portion comprises a magnetic material, and an electrically insulated material is sprayed or coated on a surface of the magnetic material.

4. The energy storage device of claim 1, wherein the magnetic portion comprises at least one magnetic layer which is disposed between the dielectric layer and the first electrode or between the dielectric layer and the second electrode, or disposed on at least one lateral surface of four lateral surfaces formed by the first electrode, the second electrode, and the dielectric layer.

5. The energy storage device of claim 4, wherein the magnetic layer is a single magnetic unit having a north magnetic pole and a south magnetic pole.

6. The energy storage device of claim 4, wherein the magnetic layer comprises a plurality of sub-magnetic units, each sub-magnetic unit has a north magnetic pole and a south magnetic pole, and the sub-magnetic units are arranged in the neighbor with the opposite magnetic poles.

7. The energy storage device of claim 1, wherein the energy storage device is an electrolytic capacitor, and the first electrode or the second electrode comprises an electrolyte.

8. The energy storage device of claim 1, wherein the energy storage device is a solid-state capacitor, a mica capacitor, a ceramic capacitor, a plastic capacitor, or a semiconductor capacitor.

9. The energy storage device of claim 1, wherein the magnetic portion is formed by the magnetic metal material selected from the group consisting of iron, nickel and cobalt or formed by an alloy or an oxide made by the magnetic metal material.

10. The energy storage device of claim 1, wherein the magnetic portion is formed by a ceramic material.

11. An energy storage device, comprising:
a first electrode;
a second electrode;
a dielectric layer disposed between the first electrode and the second electrode, the dielectric layer cooperating with the first electrode and the second electrode for achieving a capacitance effect, such that a plurality of positive charges and a plurality of negative charges are accumulated on the first electrode and the second electrode, respectively; and
a magnetic material doped in at least one of the first electrode and the second electrode for establishing a magnetic field, the magnetic field passing through the first electrode, the dielectric layer, and the second electrode.

12. The energy storage device of claim 11, wherein the energy storage device is an electrolytic capacitor, and the first electrode or the second electrode comprises an electrolyte.

13. The energy storage device of claim 11, wherein the energy storage device is a solid-state capacitor, a mica capacitor, a ceramic capacitor, a plastic capacitor, or a semiconductor capacitor.

14. The energy storage device of claim 11, wherein the magnetic portion is formed by the magnetic metal material selected from the group consisting of iron, nickel and cobalt or formed by an alloy or an oxide made by the magnetic metal material.

15. The energy storage device of claim 11, wherein the magnetic material is formed by a ceramic material.
